(19) United States
(12) Patent Application Publication
(10) Pub. No.: US 2013/0059743 A1
(43) Pub. Date: Mar. 7, 2013

(54) METHODS AND MICROARRAYS COMPATIBLE WITH DUAL FUNCTIONALITY OPTICAL DRIVES

(71) Applicant: Alexey V. ELISEEV, Brighton, MA (US)

(72) Inventor: Alexey V. ELISEEV, Brighton, MA (US)

(21) Appl. No.: 13/408,084

(22) Filed: Feb. 29, 2012

Related U.S. Application Data
(63) Continuation of application No. 12/422,742, filed on Apr. 13, 2009, now abandoned.
Application No. 12/422,742 is a continuation of application No. PCT/US2007/081442, filed on Oct. 15, 2007.
(60) Provisional application No. 60/829,308, filed on Oct. 13, 2006.

(51) Int. Cl. C40B 60/12; C40B 30/04; C40B 30/10; C40B 40/00

(52) U.S. Cl. 506/9; 506/13; 506/39; 506/12

(57) ABSTRACT

A microarray with optically recorded information and a sample capable of producing a signal as a response to external influence, or a precursor which, when activated or combined with a reagent, produces a sample capable of generating a signal. The microarray is compatible with a dual functionality optical drive. A method for acquiring information about a sample comprises directing a probe to a sample at a microarray to produce a signal from the sample, wherein the microarray is compatible with a dual functionality optical drive, and detecting the signal. The information optically recorded on the microarray can be in the CD, DVD or HD DVD or Blue Ray format.

### RELATED APPLICATIONS

This application is a Continuation of U.S. application Ser. No. 12/422,742, filed Apr. 13, 2009, which in turn is a Continuation of International Application No. PCT/US2007/081442, filed on Oct. 15, 2007, which claims the benefit under 35 USC 119(e) of U.S. Provisional Application No. 60/829,308 filed on Oct. 13, 2006, all of which are incorporated herein by reference in their entirety.

### BACKGROUND OF THE INVENTION

Microarrays have become increasingly popular in biology, biotechnology and pharmacology, making possible manipulation or analysis of multiple samples. Generally, microarrays is a piece of glass, plastic or other material comprising a plurality of different molecules such as oligonucleotides, proteins, e.g. antibodies, synthetic compounds or particles, such as cells or tissues, have been affixed at separate locations in an ordered manner. Microarrays most commonly used in analytical investigations include DNA, protein and antibody microarrays. Manipulation of biological samples typically is carried out using automated equipment or manually in a specially equipped laboratory setting.

Existing microarrays often require special equipment and procedures that limit the use of microarrays to the specialized laboratory setting, driving upwards the cost of even routine biological, environmental or clinical tests. Due to the limitations of existing microarray technologies, it is difficult and often impracticable to use microarray techniques at a point-of-care diagnostic setting, households or field conditions.

### SUMMARY OF THE INVENTION

A need exists, therefore, for apparatus and methods that addressing shortcomings of existing microarray technologies.

In one aspect, the invention relates to a microarray comprising CD, DVD or HD DVD information and a sample capable of producing a desired intrinsic signal, or a precursor which, when activated or combined with a reagent, produces a sample capable of producing a desired intrinsic signal, wherein the microarray is compatible with a CD, DVD or HD DVD optical drive. The microarray can be incorporated in an assembly that includes an optical drive or other elements such as a detector, laser and so forth. One and preferably more than one samples can be present at the microarray. In some implementations the assembly is part of a system which further includes hardware, e.g., a computer or processing unit and/or software. In other implementations, the assembly is part of a kit.

The present invention is directed to a microarray comprising optically recorded information on the microarray compatible with an optical drive; and at least one sample capable of generating a signal, or a precursor which, when activated or combined with a reagent, produces said sample. The referenced signal can be a fluorescent signal. The signal can be generated by exposing the sample to electromagnetic radiation.

The present invention is also directed to a dual functionality optical disk drive comprising an optical disk detector for receiving information optically recoded on the microarray and a microarray detector for receiving signal generated by a sample disposed inside or on the microarray. The dual functionality optical disk drive can comprise the optical disk detector and the microarray detector are integrated in one unit. In the dual functionality optical disk drive the optical disk detector receives information optically recorded in a CD, HD DVD, or Blue Ray format.

The present invention is also directed to an assembly comprising a microarray having at least one sample or precursor thereof, and optically recorded information on the microarray; and an optical drive for receiving a signal generated by the sample and for reading and/or writing said recorded information, the optical drive being compatible with the microarray. The assembly further can comprise a device for generating an illuminating radiation. The device for generating can be coupled with or integrated with the optical drive. The device for generating can be a laser source. The signal generated by the sample can be excited by electromagnetic radiation. The generated signal can be a fluorescent, phosphorescent or chemiluminsecent signal. The inventive assembly can further comprise fiber optic elements for collecting the signal. The referenced optical drive can be integral with or coupled to a computer. It is also contemplated by the present invention that the microarray comprises compartments for holding at least one sample or precursor thereof. The assembly also can comprise a plurality of samples or precursors thereof at the microarray.

The present invention is also directed to an assembly for manipulating a sample or a precursor thereof, the assembly comprising a microarray comprising at least one sample; and an optical disk drive for operating on the microarray. Furthermore, in the referenced assembly operating on the microarray comprises moving the microarray or sections thereof or modifying the structure of the microarray. The referenced assembly contemplated that the microarray comprises at least two sample compartments and the assembly includes means for opening or closing at least one partition between said compartments.

The present invention is also directed to an assembly for particle separation, the assembly comprising a microarray with samples comprising particles, and an optical drive for centrifugation of the samples. Influencing the sample is accomplished by illuminating the sample with the laser radiation. The referenced signal can be a fluorescent, phosphorescent or chemiluminescent signal. The referenced method can further comprise rotating the microarray, measuring the temperature of the sample, combining a reagent with an analyte. The analyte can be a urine sample, blood, saliva, swab, environmental or pathogen-containing specimen. According to the invention, the method can further comprise reading optically recorded information from the microarray. According to the invention, the method can further comprise writing information onto the microarray.

The present invention is also directed to a method for conducting a protocol on a sample, the method comprising holding the sample at a microarray; and combining the sample with an ingredient, wherein said combining is carried out by an optical drive.

The present invention is also directed to a method for conducting a protocol on a sample, the method comprising holding the sample at a microarray; and changing the temperature of the sample, wherein said temperature change is controlled by an optical drive.

The present invention is also directed to a kit and to a system comprising a microarray comprising optically recorded information on the microarray compatible with an optical drive, and at least one sample capable of generating a signal, or a precursor which, when activated or combined with a reagent, produces said sample.

The present invention is also directed to a method for acquiring information about a sample, the method comprising influencing a sample at a microarray to produce a signal from the sample, wherein the microarray is compatible with an optical drive; and detecting the signal.

The invention provides an apparatus and method for studying samples and can considerably increase a user's base of analytical or diagnostic tools. The invention can be employed in various applications in research, analytical or clinical laboratories, or in other applications. For instance, it can improve and simplify point-of-care diagnostic procedures and monitoring applications, such as pathogen and biohazard monitoring, field detection of biological and chemical agents, etc. In many examples, the microarray described herein is compatible with conventional CD, DVD or HD DVD players and can be used in personal computers, e.g., desktop or laptop models. Since optical discs are familiar and commonly used in the household setting, the invention can make analytical applications available to users in residential locations and in non-specialized offices and laboratories. The compatibility of the optical drive/analytical device combination with personal computer architecture enables use of the invention in households and other settings where conventional microarray-handling equipment is impracticable or prohibitively expensive.

The system and method described herein can be used in to conduct multiple tasks, e.g., provide instructions for conducting an analytical procedure, carrying out the procedure, acquiring data, handling, analyzing and presenting the results and/or comparing sample results with control samples or parameters.

A combination of conventional data storage function with analytical capabilities in a single assembly makes it possible to implement new uses, for example store the software for controlling analysis, processing the data on the microarray, writing results on the microarray, e.g., for further handlings, thus facilitating the analytical process. Once written on the microarray, data obtained can be stored, archived, forwarded to a caregiver or otherwise handled.

Analytical and diagnostic applications of optical disks drives, for example, DVD and especially of high-definition DVD drive architecture, such as BlueRay or HD DVD, can lead to the development of highly miniaturized assays. If the sample size is made comparable with the size of the information unit on a high-definition DVD, a theoretical microarray readable by such a drive can include up to 50 billion assay samples.

### BRIEF DESCRIPTIONS OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of an embodiment of the invention for using a microarray and a dual functionality optical drive.

FIG. 2A is a schematic diagram of an assembly in which laser pickup acquires a fluorescent or other light signal using a detector that combines a traditional optical drive detector and a microarray signal detector.

FIG. 2B is a schematic diagram of an assembly in which laser pickup acquires a fluorescent or other light signal where laser, lenses, prism and other elements of the pickup assembly can be moved separately or together to direct the signal to a dedicated photodetector.

FIG. 3A depicts an embodiment in which optical fibers are used to acquire a light signal.

FIG. 3B depicts projections of acceptance cones of individual fibers shown in FIG. 3A.

### DETAILED DESCRIPTION OF THE PREFERRED EMBODIMENTS

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

Conventional optical disks, such as CD, DVD, or high definition DVD (HD DVD) are used to store information. Generally, the readout of the information is performed by an optical disk drive, which directs a radiation beam, which can be a laser beam, for example, to the surface of the disk and detects changes of the beam reflection from the disk surface as the disk rotates. The changes in the reflection are caused by “bumps” on the disk surface that serve as units of the recorded information.

In the present invention the dual functionality optical disk drives that, in addition to the ability to read and write information from/to conventional optical disks, are capable of reading information (e.g. fluorescent signal) from sample or samples contained in a microarray. Such drives with dual function are defined here as optical drives with analytical capabilities.

In the present invention, at least part of the “information” detected or “read” pertains to a sample and preferably more than one sample.

The sample can be solid, liquid, gaseous, it can be a supercritical fluid or it can include a combination of two or more phases. The sample contains one and often more than one component(s). Examples of suitable samples include samples that are studied and/or analyzed in the chemical, biological, clinical, environmental, material sciences or other fields.

To acquire information about the sample, at least one property, e.g a physical, chemical or biological property, of the sample is detected. Examples of sample properties that can be detected include the presence or absence of specific compounds in the sample, rendering the system and method described herein useful in analytical tests, e.g., during clinical or cytological examinations, diagnostic procedures and other applications. One of the more useful physical properties that can be detected is the intensity of light and its changes resulting e.g. from fluorescence, light absorption and reflection by the sample. Temperature, turbidity, electrical or thermal conductivity, index of refraction and many other physical properties also can be detected.

In some implementations, changes in a property can be detected over a time period and/or as a result of adding ingredients, conducting chemical reactions, altering conditions such as temperature, nature of solvents, catalysts, position of certain species within the sample (e.g. caused by centrifugal forces) or other ingredients added to the sample, and so forth.

Changes that can be monitored include changes in physical properties such as seen during dissolution, crystallization, aggregation, phase transitions, etc. Chemical transformations such as those taking place during chemical reactions also can be studied, for instance, by monitoring the appearance or disappearance of one of the components present in the sample, detecting intermediate species, byproducts, photon absorption or emissions associated with the reaction or by other approaches known in the art.

To acquire the information, the sample is exposed to an incident beam of radiation and a signal is generated as a result of that incident radiation and can be detected by a suitable detector.

In some of the preferred embodiments of the invention, the illuminating radiation is electromagnetic radiation, while signal detection is based on a suitable spectroscopic technique. Examples include fluorescence, e.g., obtaining excitation or emission spectra of one or more sample components, phosphorescence, chemiluminescence, change in light intensity due to absorption, light reflection and change of reflection, light scattering, and others.

In other preferred embodiments, the signal detected is an “intrinsic” signal of the sample, in other words, it is generated by the sample itself. To facilitate or enhance detection by spectroscopic techniques such as fluorescence, the sample can be combined with or can incorporate staining agents, fluorophores or other suitable ingredients. Selection of these ingredients depends on the technique employed, nature of the sample, and so forth.

In specific examples, the sample includes an ingredient capable of generating a signal upon excitation by electromagnetic radiation. For a sample excited using light at wavelengths 405 nanometers (nm), for instance, fluorophores with the excitation maxima close to 405 nm that can be employed include, among others, cyan and blue fluorescent proteins, Cascade Blue dye, dyes Alexa Fluor 405 and 430, and quantum dots. Fluorophores that can be used with an excitation wavelength of 640 nm include allophycocyanine, cyanine dye Cy5, dyes Alexa Fluor 633 and 647, ATTO dyes 633, 647, and 645, quantum dots, fluorescent microparticles such as PAN and PD and their conjugates, fluorescent molecular rotors, and so forth.

Chemical moieties or groups known to produce fluorescence or other suitable signals can be incorporated into the molecular structure of the sample or component(s) thereof.

The sample or samples being studied is/are at a microarray, e.g., on or within the body of the microarray. As used herein, the term “microarray” refers to a substrate or a device capable of housing or holding one and preferably more than one sample being investigated or one or more precursors thereof. In specific implementations of the invention, the microarray is compatible with optical drives having analytical capabilities and can be used in a personal computer, e.g., a desktop or laptop.

Suitable microarrays can be made in a variety of shapes and designs. Particularly preferred are microarrays shaped as a compact disk, circular or otherwise, having cells or compartments housed on or inside the disk or mounted on a surface of the disk. The cells or compartments can be in the shape of cavities, recesses, capillaries, tubes, microchannels or can be other types of containers.

The compartments can be shaped or dimensioned according to the application. For example, compartments can be sized to ensure that each can be individually probed. For some laser beam applications, for example, the compartments can be dimensioned according to the laser spot illuminating the sample. In a particular example, the size of a compartment is such that it allows for readout of the light signal from each individual compartment and the compartment size can depend on the size of the laser spot created by the focusing mechanism employed.

In specific implementations the microarray contains very small samples, comparable in size to the information units on a high-definition DVD (about 0.1 micrometers) and the microarray can be manufactured using, for instance, ink-jet printing, microlithography, or nanolithography technolodies.

The compartments in the microarray can be fabricated to permit changes in the compartment structure. For example, compartments can be divided by walls made of plastic materials permitting sealing or melting the walls by lasers or other heat sources. Freezing also can be used to change compartment structure.

The microarray can be provided with inlet(s) and/or outlet(s) for sample loading, adding and/or removing reagents, spent solvents, byproducts or other ingredients. Compartments can be provided with electrical connectors, for instance, for exposing a sample to external influence that is an electrical current, or for affecting, influencing or changing the properties of the microarray or the samples, such as temperature, compartment structure, electrophoretic mobility, etc.

The microarray can include samples being investigated or analyzed (unknown samples), as well as known or control samples.

In some implementations the sample or samples is/are preloaded on or into the microarray, e.g., in the compartments. In other implementations the sample(s) is/are added to the microarray, e.g., to the compartments, during or just before acquiring information about the sample, for instance, by using a syringe, opening conduits to reservoirs containing the sample, or by other suitable means. In many cases, the sample is formed from precursors, for instance by combining an analyte with one or more reagent(s). As used herein, the term “analyte” refers to a sample that can be loaded onto or into the microarray and interact with the microarray, so that the physical, chemical and/or biological composition of such an analyte, or changes in such a composition, can be determined by the dual functionality optical drive.

In preferred examples the microarray is provided with a suitable reagent which, when combined with an analyte, forms a sample capable of generating an intrinsic signal, for example, fluorescence. In such a case the analyte itself does not generate the desired signal, but is capable of generating the signal after being mixed or combined with the reagent. In specific examples, the analyte reacts with, binds or otherwise interacts with a substrate reagent applied to or deposited into the compartments of the microarray. In other instances, the compartment itself—the microarray or sections thereof—can be fabricated from a precursor material, e.g., a reagent, which, when combined with one or more other precursor(s), such as an analyte, forms the sample having the intrinsic signal.

A precursor, such as an analyte, that does not generate a desired intrinsic signal, can be activated to form a sample that has the desired intrinsic signal, for example, a fluorescent signal. Activation of the precursor can be carried out, for example, by temperature modification, chemical decomposition and so forth.

Examples of the analytes that can be added to the microarrays include (but are not limited to) blood, saliva, urine, swabs, for DNA testing, as well as pre-treated analytes such as the ones used in PCR routines. In such PCR routines RNA can be first isolated using conventional techniques, environmental, e.g., air, water or soil specimens, specimen containing pathogens and so forth, and then reverse-transcribed to create cDNA used in the PCR analysis.

Adding the desired analyte to the microarray can be carried out by contacting, rubbing, using medicine droppers, syringes, by opening conduits between microarray compartments, or other suitable techniques.

In addition to housing one and preferably more than one sample(s), for example, a sample formed by adding an analyte to a reagent present at the microarray, the microarray includes optically recorded information. Specifically, such optically recorded information can be CD, DVD, HD DVD or Blue Ray format information. That information can be provided on segments or sectors of the optical disks. That information can relate, for example, to the procedures to be followed in sample analysis, normal ranges for clinical tests, protocols for pathological investigations, procedures for analyzing, writing and/or displaying data, and so forth. Of course, it can be any other kind of information written on the optical disks, as called for by a particular application. As used herein, CD, DVD or HD DVD information refers to information written and/or read on or from a CD, DVD or HD DVD by techniques employed, for example, in writing and reading conventional compact, DVD or high-definition DVD discs.

As used herein, the term “dual function microarray” refers to a microarray that contains at least one sample or sample precursor, as well as optically recorded information. As an example, the CD, DVD or HD DVD, or Blue Ray format for recording information can be used.

The microarray can include elements capable of changing and/or maintaining the temperature of the samples in the microarray. Such elements can be electric wires or coils. The microarray can also include parts that can change temperature upon irradiation, e.g., with a laser. In some cases, different sections of the microarray can be maintained at different temperatures.

The microarray can also include temperature-sensitive fluorescent dyes that can be used to measure the temperature in the microarray via the excitation of the dyes with the laser and measuring fluorescent signals of the dyes. Such a temperature measurement can be used to establish a feedback connection between the optical drive and the microarray to precisely control and maintain the temperature or thermostat the microarray.

In further embodiments, coatings that enhance a signal generated by the microarray in the presence of an analyte also can be utilized. The coatings can be applied over the entire microarray or to specific compartments or sectors, and can serve, for example, to minimize background signal or noise by absorbing or transmitting light in the absence of the analyte.

A laser or another heat source can be used to alter the structure of the microarray or its parts, which can affect solution mixing, transfer and microfluidics, triggering a chemical reaction, biological process, or an analytical signal. This can be performed by opening/closing channels and compartments, or other storage components in the microarray, surface etching, or other operations. For example, heating of the disk or specific compartments by a laser or any internal of external heat source can result in melting walls composed of thermosensitive materials and mixing solutions from different compartments. Such mixing can result in a chemical reaction, biological process and/or generating an analytical signal.

In a preferred embodiment, the microarray is rotated much as a compact disk is rotated in a conventional CD player or a CD-DVD drive. Rotation of the microarray can be continuous, for example at a constant speed. Step-wise rotation also can be implemented, for instance to bring a compartment or a section of the microarray into a desired position, followed by maintaining the position for a period of time suitable for carrying out the study of the sample at that position, and restarting the rotation to bring the next sample in the desired position.

If desired for analytical or diagnostic purposes, the samples in the microarray can be mixed, moved, transferred from one compartment to another, or agitated by movement of the microarray, e.g., the rotation described above or any other movement of the microarray.

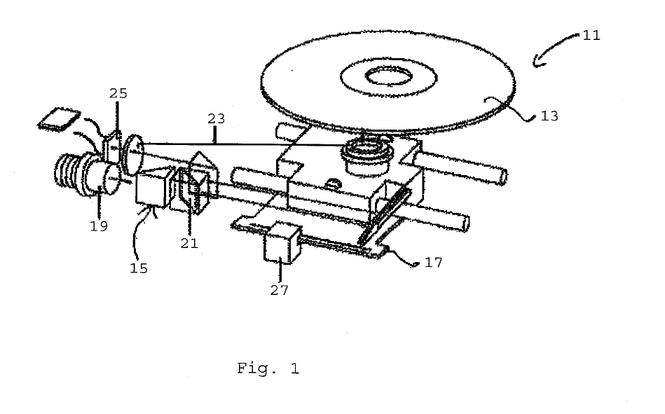

Shown in FIG. 1 is arrangement 11 comprising a rotatable support for microarray 13 which is CD/DVD compatible and laser diode assembly 15 which is mounted on mini-rails 17 so that it can be moved along the radial line of the disk. Laser diode assembly 15 comprises laser diod 19, and optical elements including prisms and beam splitters 21 for directing the light, and lenses 23 for focusing the laser beam and photo detector 25. Servo motor 27 can be employed to drive the movement of the laser diode assembly relative to the microarray.

As used herein, the term “optical disk drive” (or optical drive) refers to a device capable of reading information and/or recording information on compact disks, including CD, CD-R, CD-RW, DVD+R, DVD+RW, DVD-RAM, DVD-R, DVD-RW, DVD-ROM, high-definition DVD such as BlueRay and HD DVD formats. The definition of an optical drive also includes devices similar to the CD and DVD drives described above, but with added and/or modified features, characteristics, and provided with suitable hardware or software to enable these drives to acquire information about a sample. Acquiring information about a sample occurs by probing, detecting, and/or analyzing at least one property in a sample. As used herein the term “optical disk drive” also refers to the devices similar to the CD and DVD drives described above, designed for performing one or more operations on the microarray, as further described below.

Much as conventional optical drives, the optical drive described herein can read information provided on one or more sectors of the microarray. Such information can pertain, for instance, to the procedures and protocols employed during sample analysis. For example, it can include software for controlling the microarray operations, sample manipulations, and data analysis.

In the preferred aspects of the invention, the optical drive powers and controls the movement of the microarray, such as rotation, for example. In other preferred aspects of the invention, the optical drive carries out one or more operations commonly undertaken during analytical or diagnostic procedures. Examples include, but are not limited to, mixing, agitation or stirring of ingredients in compartments, transfers in and out and between compartments, temperature modifications of samples and solutions, adding reagents, drying, probing the sample, e.g., using a light beam, and many others.

To effect such operations, the optical drive is provided with suitable equipment or devices. For example, the optical drive can be equipped with a power supply, e.g., electric contacts, for the microarray. Elements such as wires or coils, used, e.g., in changing or maintaining the array temperature or melting dividing walls also can be powered and/or controlled by the optical drive.

In specific examples, the optical drive is equipped with means to heat, cool or maintain a desired temperature in the microarray. Heating, cooling or thermosetting devices include, for example, solid heating elements, e.g., Peltier-type; stream of air; use of lasers and materials based on nanoparticles, such as those described in Hugh H. Richardson, Zackary N. Hickman, Alexander O. Govorov, Alyssa C. Thomas, Wei Zhang, and Martin E. Kordesch, Nano Lett.; 2006; 6(4) pp 783-788 and others.

The optical drive can include a device such as, for instance, a laser, that generates illuminating radiation used in generating a response signal and acquiring information about a sample. The illuminating radiation also can be generated independently of the optical drive.

In preferred embodiment the optical drive includes at least one laser. Lasers can produce visible or ultraviolet light, infrared radiation or energy at other regions of the electromagnetic spectrum. Suitable lasers can generate one or more discrete frequencies or can be tunable over an entire region of the electromagnetic spectrum.

In specific examples, at least one laser employed is one commonly found in DVD drives, such as a red laser, that emits light at 640 nanometers (nm). In other examples, the laser is of the type typically used in high-definition DVD drives, such as BlueRay, and HD DVD drives, such as a blue laser that emits light at 405 nm. Wavelengths generated by the lasers found in conventional optical drives are within the range of absorbance of a wide variety of chromophores and fluorophores and, therefore, can be used in fluorescent analysis and diagnostics. Combinations of lasers can also be employed for the described purposes.

In addition to being used for spectroscopic investigations of the analyzed sample, a laser can be employed to alter the structure of the disk or its parts, which can affect solution mixing, transfer and microfluidics, triggering a chemical reaction, biological process, or an analytical signal. This can be performed by opening/closing channels and compartments, or other storage components in the disk, surface etching, or other operations. For example, heating of the disk or specific compartments by the laser, or any internal of external heat source, can result in melting walls composed of thermosensitive materials and mixing the solutions from different compartments. Such mixing can result in a chemical reaction, biological process and/or generating an analytical signal.

Other sources of electromagnetic radiation, such as, for instance, microwaves generators also can be utilized.

The lasers, or other sources of electromagnetic radiation, often are used in conjunction with other elements such as minors, lenses, frequency doubling crystals, prisms, dye cells or other optical elements or other devices, as known in the art.

Furthermore, signals, such as visible light signals, obtained upon exposing a sample to an electromagnetic radiation, are detected using one or more suitable detectors or sensors. Such sensor or sensors can be spatially or functionally combined with one or more sensors present in a conventional CD/DVD drive or positioned at a different location, either on the same side or on the opposite side of the microarray. The detector(s) can be arranged to receive signals from a single location on the microarray or to receive signals from different locations on the microarray. In preferred embodiments of the invention, signals from the sample at the microarray are received at the optical drive—either directly at a sensor located at the optical drive, or indirectly by transmitting a signal collected by a detector, disposed not at the optical drive, to the optical drive. Signals can be processed by the optical drive or transmitted to an external receiver either in their original format or in the converted format, for example, digitized. The external receiver can be, for instance, a computer.

In some implementations, signals are digitized.

Examples of suitable sensors/detectors include photodetectors, CCD (charge coupled device), CMOS (complementary metal oxide semiconductor), photo multiplying tube (PMT) or any other devices sensitive to electromagnetic radiation.

In the preferred embodiments, a detector is capable of acquiring light of different wavelengths. Also preferred are the detectors/sensors capable of quantifying the light intensity. In specific implementations of the invention, the detector/sensor includes one or more fiber optic element(s). When multiple compartments emit light, the fiber optic elements can be used to isolate the signal from a specific compartment in the microarray.

Since in conventional optical drives the laser pick up assembly is positioned on the tracking mechanism, additional features related to the analytical applications described herein can be embedded or added to the existing laser data pick up assembly, allowing the light detector to acquire signals from samples in specific positions on the microarray.

Focusing of the laser beam on the analyte and varying the size of the light spot on the sample can be carried out using an objective lens and other elements of the optical system of the assembly. In the preferred implementations, the size of the laser light spot on the microarray is varied to cover a single sample or a group of samples.

Optical elements, such as those described above, can also be powered and controlled independently of the optical drive. For example, the microarray itself can include a battery for powering the heating elements, such as coils or wires.

The optical drive can contain hardware and software for implementing one or more of the operations described above, as well as other operations. Such operations can relate to various instructions for performing the analysis, tutorials, calibrations, data analysis or processing, display of results and recommendations based on the analysis. Such operations can also relate to the interfacing with an outside reviewer, such as a controller, caregiver, a doctor, archiving facility and so forth.

The optical drive can be connected to the internet or any other type of wireless or wired network, either through a computer or directly. In one example such a connection makes it possible to exchange information between the primary point of analysis or diagnostics and a remote location, such as a physician's office.

The optical drive can be interfaced with a computer system used for programming and controlling operations performed by the drive on the microarray, such as irradiation with the laser, rotation, processing signals acquired from the microarray, storing protocols followed during sample analysis, processing data, and displaying the results.

The analytical/diagnostic functions of the optical drive can be further enhanced by the addition of an interface between the optical drive and an external controller, such as a processing unit or computer. In specific embodiments, such an interface performs the following (non-exhaustive) list functions:
turning the laser on/off by the external controller and controlling laser intensity by an external controller.
transmitting the information between the light sensor and external controller. This function can include the information about the wavelength and intensity of light signal.
controlling the position of the microarray in the drive by an external controller, so as to direct the laser beam to and take the signal readout specific location on the microarray.
focusing the laser beam and adjusting the spot size of the beam to a particular sample size.
switching the rotation of the microarray on and off and controlling the rotation speed from an external controller.
controlling the temperature in the microarray by an external controller, using one or more of the mechanisms described below.

The processing unit also can be part of the dual functionality optical drive.

One example of an interface that allows for controlling the operations of the drive and the disk with the aid of the computer is the LightScribe technology (www.lightscribe.com), developed by Hewlett Packard Development Company L.P. This technology enables the printing of images, designed by the user via special software, on the surface of special compact disks. The LightScribe technology printing involves manipulating the disk and/or the laser of the optical drive so as to direct the laser beam on the specific point of the disk for a given period of time.

The addition of the analytical readout capability to the optical drive enables such functionality of the optical drive that does not exist in a regular CD/DVD drive or in a regular microarray reader. For example, a microarray made in the shape of a compact disc may contain informational segments with recorded instructions for handling the analytical/diagnostic procedure or software that enables a computer to control such procedure and analyze the results of the readout. This information and software is read by the informational unit of the drive, while the operations on the microarray or parts thereof are performed by the analytical unit.

Several specific implementations of the invention are described below.

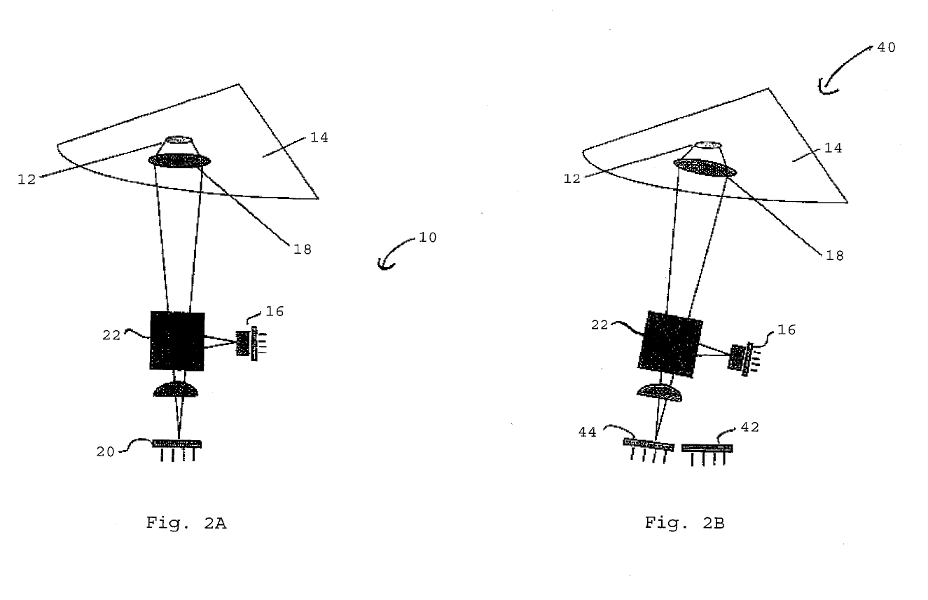

In one embodiment, the assembly of the invention employs the geometry found in conventional CD/DVD systems. Shown in FIG. 2A is assembly 10 suitable for detecting fluorescence emitted from sample 12 housed in microarray sector 14. Laser 16 generates incident light and objective lens 18 is employed to focus light to and from sample 12. Assembly 10 also includes detector 20, for example, a PDIC (photo detector integrated circuit) type detector, modified to contain elements responsible for reading conventional data disks, for example DVD, referred to herein as the optical disk detector; and elements receiving the light signal from the sample referred to herein as the microarray detector. Beam splitter 22 can be employed for separating the respective signals.

For most applications, the microarray detector elements are more sensitive than those of the optical disk detector, because they detect a secondary light signal, such as fluorescence. To avoid saturation of the microarray detector with the primary laser beam reflected from the disk, the sensors of the microarray detector can be made insensitive to the wavelength of the laser and only sensitive to the wavelength of the emitted fluorescent signal. Alternatively, the microarray can contain a dichroic mirror or a filter that prevents the reflection of the laser light and only directs the fluorescent signal to the detector.

In another implementation of the assembly, the laser, lenes, prism and other elements can be moved separately or together to direct the light signal from the microarray to a microarray detector. Shown in FIG. 2B is assembly 40 for detecting fluorescence from sample 12 housed in microarray sector 14. Assembly 40 includes laser 16 and objective lens 18, essentially as described above. Detector 42 is an optical disk detector (for reflected light), while detector 44 is employed to detect signals from the microarray. Directing of the light signal to the microarray detector can be performed using beam splitter 22. As discussed above, a dichroic minor (not shown in FIG. 2B) that reflects specifically the light at the wavelength of the emitted signal can be embedded in the optical mechanism of the assembly.

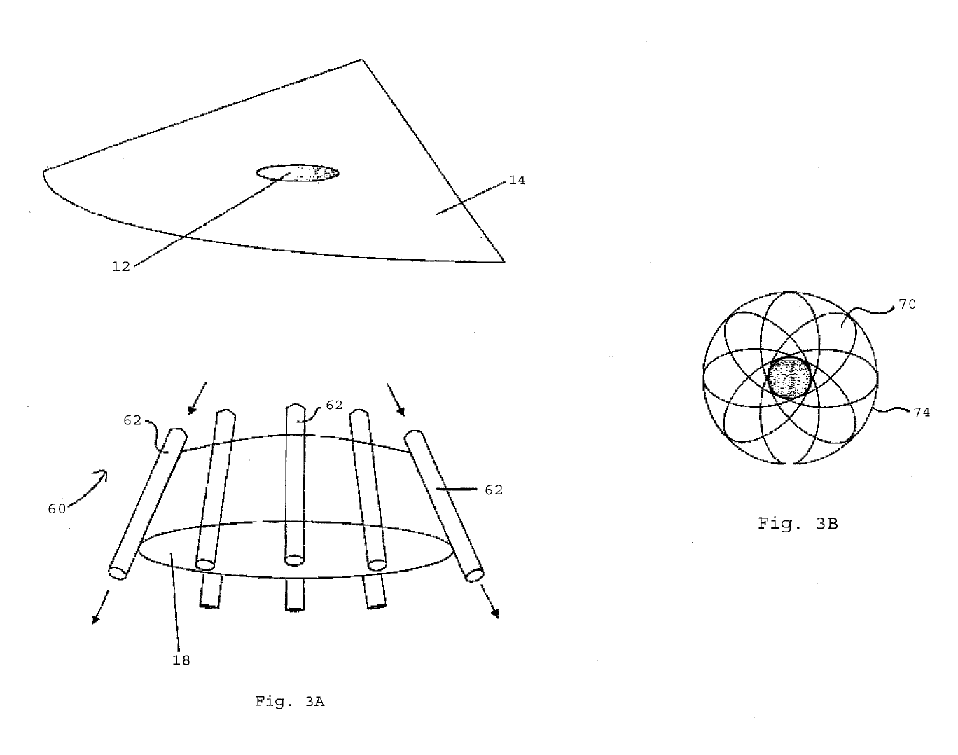

In yet another implementation, the assembly employs optical fiber elements. Shown in FIG. 3A is assembly 60 including a plurality of optical fibers 62. Bundles of optical fibers also can be used. Optical fibers 62 are directed to the sample being analyzed, sample 12 at microarray sector 14. Optical fibers 62 transmit the light signal, such as fluorescence, from the microarray to a detector or detectors that can be located anywhere in the assembly or outside of it. In the implementation shown in FIG. 3A, optical fibers 62 are grouped around objective lens 18 of the assembly, or a suitable enclosure of the objective lens, not shown in FIG. 3A.

In a preferred arrangement, optical fibers 62 are slanted around as a truncated cone, and are pointed toward the sample. This design avoids saturation of the detector with the reflected laser light without using additional filters or mirrors.

In a further preferred arrangement, the types and position of fibers 62 are such that the fibers receive the signal from an area comparable with the size of the sample, as illustrated in FIG. 3B. Shown in FIG. 3B are ovals 70 which refer to the projections of the acceptance cone of individual fibers 62, with outer circle 74 corresponding to the optimal sample size.

In other embodiments, what is measured is the intensity of the light passing through the microarray. Suitable arrangements employ light detectors positioned on the side of the microarray opposite to the laser assembly. The microarray also can be provided with a mirror for reflecting the laser light, so that the light passes through the sample twice (on the way to the minor and back). The absorbance of the light by the samples in the latter case can be quantified by comparing the intensity of the reflected light in the analyzed sample with intensity of reflected light in a controlled sample.

With samples that scatter light, arrangements for detecting or measuring light scattering also can be employed.

The optical drive described herein used in combination with the appropriate microarray and/or kit can be used to determine a composition of a broad range of analytes or changes in such composition. As used herein, the term “kit” refers to a set of materials, reagents, supplies, as well as descriptions of procedures, software, and so forth that enable the acquisition of information from the microarray by optical drive.

Examples of the assays that can be performed using the method, assembly or kit described herein include (but are not limited to) the following:
Direct binding assays with the readout based on fluorescence, light absorbance, scattering, reflection, and other optical signals.
Direct immunofluorescent assays.
Enzyme and enzyme inhibitor assays using fluorescent, absorbance and other optical readouts.
Immunoenzyme assays, including ELISA.
Nucleic acid hybridization assays.
Assays of oxygen, nitric oxide and other small molecules.
Assays based on time-resolved fluorescence measurements.
Fluorescence resonance energy transfer (FRET) assays.
Assays where source of fluorescence are quantum dots.
Monitoring of the kinetics of chemical and biological processes occurring in the microarray.
Direct detection of living organisms, including pathogenic, such as viruses or bacteria.
Flow cytometry assays, including the applications combined with particle separation in the optical drive and real-time monitoring of the separation process, as described below.
Imaging applications, in which the analyte or sample can be positioned in the microarray, so that its two- or three dimensional structure and composition can be determined using the optical drive.

The analytical and diagnostic applications listed above can be used as individual techniques, combinations of the techniques, and also in combination with other processes, for example, with centrifugal separations and hydrodynamic focusing, as described below.

Furthermore, chemical reactions and biological processes in the microarray can be initiated, controlled, and monitored using various optical drive/microarray/kit combinations.

The system and method described herein can be utilized to simultaneously conduct multiple experiments, using, for instance, statistical experimental designs, in the course of developmental or scale-up research.

One specific application an optical drive/microarray/kit combination is real-time or quantitative PCR (polymerase chain reaction). A routine or protocol for performing real-time PCR is described, for instance, by Valasek M A, Repa J J: The Power of Real-Time PCR, Adv. Physiol. Educ. 29, 151-159, 2005.

In one embodiment of the invention, real-time PCR is performed in the compartment(s) of a microarray, in which the temperature cycle is induced and controlled via one of the aforementioned mechanisms of temperature control. The signal of fluorescent or other spectral probes indicative of the progress of the reaction is induced and/or and monitored using the laser, the light sensor, and other elements of the optical drive described above.

The real-time PCR can also be performed in numerous implementations, including, but not limited to the following:
Using different analytes in different compartments of the microarray.
Using different primers in different compartments of the microarray.
Using different temperature cycles for different compartments of the microarray.

A protocol for real-time PCR can involve a conventional PCR process controlled by temperature cycling in which the quantity of the DNA amplified is measured at the exponential stage of amplification using oligonucleotides labeled with fluorescent tags. A diagnostic drive suitable for real-time PCR assays can utilize optical drive/microarray combinations capable of cycling the temperature, preferably in the range between about 50 and about 96 degrees C.

In one example, a Quiagen QuantiTect SYBR Green PCR Kit can be used. 10 μl of 2×PCR Master Mix from the Kit is premixed with 0.4 μl of a 10 μM stock solution of forward primer, 0.4 μl of a 10 μM stock solution of reverse primer and 8.20 of RNAse-free water and immediately before the reaction mixed with 1 μl of the analyte (cDNA solution). The mixing operations can be performed by a variety of microfluidics operation depending on the specific design of the microarray, wherein the liquid transfer and solution agitation is facilitated by the rotation of the microarray inside the optical drive. The mixing of the solutions can be also achieved by melting the walls between the compartments in the microarray, e.g. by heating or the action of the laser of the optical drive. The following thermal cycling protocol is then applied using the heating elements of the optical drive and/or microarray: (1) 2 minutes at 50° C. (incubation); (2) 15 minutes at 95° C. (Taq activation); (3) 40 cycles of the following: (3a) 15 seconds at 95° C. (denaturation), (3b) 30 seconds at 56° C. (annealing), (3c) 30 seconds at 72° C. (extension). During the extension cycle, detection of the sample fluorescence upon irradiation of the sample with the laser of the optical disc drive is performed. The software is then used to process the raw fluorescence data by the computer interfaced with the optical disc drive.

In further embodiments, a combination of an optical drive, microarray, and a kit is used to separate the particles in analytes and samples by their size and hydrodynamic properties. Such a separation can be achieved due to different centrifugal mobility of the particles during the rotation of the microarray. This property can be used for centrifugal separation and hydrodynamic focusing of particles, such as living cells. The centrifugal force can also be used for different separation mechanisms, such as differential permeation of particles through membrane filters embedded in the microarray or through other permeability barriers.

In the optical drives described in the present invention, the laser beam can be focused on specific particles of various sizes. For example, the small diameter of the focused high definition DVD blue laser beam (about 0.1 micrometers) technically allows the drive to detect, enumerate, and acquire an optical signal from viral particles (typical size range 0.02-0.4 micrometers) and distinguish them from larger particles, such as bacteria (typical size range 0.5-500 micrometers). Thus, the combination of optical drive/microarray/kit can be used for cytometric and imaging applications.

Separation of the particles by centrifugal forces in the optical drives/microarrays can be combined with detection, enumeration, quantification, and analysis of the separated particles with the laser beam, as described above. The combined application can be used for real-time monitoring of the separation processes, such as flow cytometry and similar particle detection and enumeration techniques. Such a monitoring can be combined with other assay techniques, for example, fluorescent labeling of the particles with structure-specific reagents, such as antibody conjugates.

The combination of optical disk drives, microarrays, and kits can be used for detection and quantification of biologically active compounds and organisms, including, but not limited to, protein markers, such as antibodies, enzymes, receptors, regulatory peptides and proteins, nucleic acids, carbohydrates, steroids, including cholesterol, metabolites, viruses, bacteria, and other pathogenic organisms.

While this invention has been particularly shown and described with references to preferred embodiments thereof, it will be understood by those skilled in the art that various changes in form and details may be made therein without departing from the scope of the invention encompassed by the appended claims.

What is claimed is:

1. A microarray comprising:
a. optically recorded information on the microarray compatible with an optical drive; and
b. at least one sample capable of generating a signal, or a precursor which, when activated or combined with a reagent, produces said sample.

2. The microarray of claim 1, wherein the signal is a fluorescent signal.

3. The microarray of claim 1, wherein the signal is generated by exposing the sample to electromagnetic radiation.

4. The microarray of claim 1, wherein the reagent is an analyte.

5. A dual functionality optical disk drive comprising an optical disk detector for receiving information optically recoded on the microarray and a microarray detector for receiving signal generated by a sample disposed inside or on the microarray.

6. The dual functionality optical disk drive of claim 5, wherein the optical disk detector and the microarray detector are integrated in one unit.

7. An assembly comprising:
a. a microarray having:
i. at least one sample or precursor thereof; and
ii. optically recorded information on the microarray; and
b. an optical drive for receiving a signal generated by the sample and for reading and/or writing said recorded information, the optical drive being compatible with the microarray.

8. The assembly of claim 7, further comprising a device for generating an illuminating radiation.

9. The assembly of claim 8, wherein the device for generating is coupled with or integrated with the optical drive.

10. An assembly for manipulating a sample or a precursor thereof, the assembly comprising:
a. a microarray comprising at least one sample; and
b. a dual functionality optical disk drive for operating on the microarray.

11. The assembly of claim 10, wherein operating on the microarray comprises moving the microarray or sections thereof or modifying the structure of the microarray.

12. The assembly of claim 10, wherein the microarray comprises at least two sample compartments and the assembly includes means for opening or closing at least one partition between said compartments.

13. A method for acquiring information about a sample, the method comprising:
a. influencing a sample at a microarray to produce a signal from the sample, wherein the microarray is compatible with a dual functionality optical drive; and
b. detecting the signal.

14. The method of claim 13, wherein influencing the sample comprises illuminating the sample with a laser.

15. The method of claim 13, wherein the signal is a fluorescent, phosphorescent or chemiluminescent signal.

16. The method of claim 13, further comprising rotating the microarray.

17. The method of claim 13, further comprising writing information onto the microarray.

18. A method for particle separation, the method comprising rotating at least one sample at a microarray and controlling rotation at least one sample with a dual functionality optical drive, wherein at least one sample comprising the particles and wherein the microarray is compatible with a dual functionality optical drive.

19. The method of claim 18, wherein the particles are cells.
